(19) United States
(12) Patent Application Publication
(10) Pub. No.: US 2001/0032297 A1
(43) Pub. Date: Oct. 18, 2001

(54) Cache memory apparatus and data processing system

(76) Inventors: Naoto Morikawa, Atsugi (JP); Toshihiko Kurihara, Hadano (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/797,599

(22) Filed: Mar. 5, 2001

(30) Foreign Application Priority Data
Mar. 3, 2000 (JP) 2000-059141

(51) Int. Cl. G06F 12/08

(52) U.S. Cl. 711/133; 711/119; 711/137

(57) ABSTRACT

A cache memory apparatus that enables cache misses in the event of cache block conflict to be reduced and a cache memory situation to be easily inferred from outside, and a high-performance data processing system that uses this. There is provided a cache memory apparatus 5 having two cache memories that do not have an inclusive relationship between a processor 1 and lower-level memory 9 such as L2 cache memory or a main memory apparatus. Data transfer is controlled explicitly by software for one cache (naked cache) 6, and data that causes a cache-miss is transferred to the other cache (cache-miss cache) 7. Thereby, it is possible to provide a cache that is easily controlled by software, and to minimize a cache-miss penalty when explicit control by software is not possible.

### BACKGROUND OF THE INVENTION

The present invention relates to a cache memory apparatus and data processing system, and relates in particular to a cache memory apparatus that enables to reduce cache misses in the event of cache block conflict and a data processing system utilizing the same.

In general, data used by a computer has spatial and temporal locality. Cache memory is used as a method of accessing data at a faster speed, using this property. Cache memory is configured by a small quantity of memory that can be accessed at a faster speed, and data from the main memory is copied to it. By performing main memory accesses on the cache memory, the processor can execute memory accesses at a faster speed.

And, cache memory operates in the following way. For a memory access from the processor, cache memory first checks whether that data is present in the cache memory or not. If the data is present in the cache memory the cache memory transfers the data in cache memory to the processor. If the data is not present, execution of the instruction that requires that data is interrupted, and the data block containing that data is transferred from the main memory. In parallel with this data transfer, the requested data is transferred to the processor and the processor restarts execution of the suspended instruction.

As described above, if the data requested by the processor is present in the cache memory, the processor can acquire the data at the access speed of cache memory. However, if the data is not present in the cache memory, the processor has to delay execution of the instruction while the data is transferred from the main memory to the cache memory. The situation in which the data is not present in the cache memory when an access is made is called a cache miss. A cache-miss may occur due to a first reference to data, insufficient cache memory capacity, or cache block conflict.

A miss due to the first reference to data occurs when an initial access is made to data within a cache block. That is to say, when the first data reference is made, the cache memory does not contain a copy of main memory data, and data must be transferred from the main memory.

A miss due to insufficient cache memory capacity occurs when the cache memory capacity is not sufficient to contain the data blocks necessary for program execution, and a number of blocks are discarded from the cache.

A miss due to cache block conflict (conflict miss) occurs in direct-mapped and set-associative cache memory. With these kinds of cache memory, main memory addresses and data sets in the cache are associated, and so if there are accesses to the same set from multiple processors, conflict occurs, and even frequently used data may be forcibly purged from a block. If accesses are concentrated on the same set, in particular, successive conflict misses will occur (a state known as thrashing), greatly decreasing cache performance, and in turn the performance of the data processing system.

Regarding the above described conflict misses, many proposals have been made for reducing cache misses.

For example, with the associative method, a method of reducing conflict misses by applying skew when mapping, using multiple mapping relationships, etc., has been described in ‘C. Zhang, X. Zhang and Y. Yan, “Two Fast and High-Associativity Cache Schemes,” IEEE MICRO, vol. 17, no. 5, Sep/Oct, 1997, pp. 40-49’.

A method is also know whereby conflict misses are reduced by installing a small fully-associative cache (victim cache) between a direct-mapped cache (main cache) and the main memory. This method is described in ‘N. Jouppi, “Improving Direct-Mapped Cache Performance by the Addition of a Small Fully-Associative Cache and Prefetch Buffers,” Proc. 17th Int'l Symp. Computer Architecture, pp. 364-373, May 1990.’ With the method described in this publication, if a block purged from the main memory due to a conflict is temporarily stored in the victim cache and is referenced again while the block is in the victim cache, data can be transferred to the processor at a small penalty.

Also, a method called selective victim caching has been described and proposed as an improvement on the above described method in ‘D. Stiliadis and A. Varma, “Selective Victim Caching: A Method to Improve the Performance of Direct-Mapped Caches,” IEEE Trans. Computers, Vol. 46, No. 5, MAY 1997, pp603-610’. With this method, block data transferred from the main memory is stored in either the main cache or a victim cache. Which of these the data is stored in is determined by the future possibility of that block's being referenced based on the past history of the block: the data is stored in the main cache if the possibility is judged to be high, and in the victim cache otherwise. When data in the victim cache is referenced, a decision is also made on whether or not to store that block in the main cache based on its past history.

Further, a stream buffer technology using the property of the spatial locality of data has been proposed as one of the prefetch buffers shown in the above described publication by N. Jouppi. A stream buffer is located between the cache memory and main memory or secondary cache memory that is memory at a lower level in the memory hierarchy. With this technology, when a prefetch instruction or load instruction is issued and the relevant data is not present in the cache memory, a data transfer request is made to lower-level memory, and at this time, the data is first transferred to the stream buffer and then from the stream buffer to the cache memory. When this data transfer is performed, not only block data at the specified address but also data stored at the next address is transferred to the stream buffer.

In general, when a prefetch instruction or load instruction is issued and storing data in cache memory is performed, due to the property of spatial locality of data there is a high probability that the next load instruction will have an address near the previously loaded data.

Thus, by transferring not only the block data at the specified address but also data stored at the next address to the stream buffer when prefetching or loading data in lower-level memory, as described above, there is a high probability that the address indicated by the next load instruction is already stored in the stream buffer. As a result, it is possible for the data for the next load instruction to be transferred to the cache memory from the stream buffer, rather than from lower-level memory, eliminating the necessity of issuing a new data transfer request to lower-level memory, and making possible high-speed memory access.

Also, technology relating to the prefetch buffer method is presented in ‘“MICROPROCESSOR REPORT,” vol. 13, Num. 5, Apr. 19, 1999, pp. 6-11’. With the technology presented here, a buffer called scratchpad RAM is provided in parallel with the data cache, and the memory space stored in the data cache and the memory space stored in the scratchpad RAM are made logically separate spaces. A bit (S bit) is provided in the page table entry, and if the S bit is raised data is stored in the scratchpad RAM. The main purpose of this technology is to avoid thrashing the cache with long strams of continuous video address whose data is not reused within a video frame.

Cache memory employing the above described conventional technologies has the kinds of problems described below.

With the above described victim cache, since data purged from the main cache is transferred to the victim cache, there is a problem of valid data being purged from the victim cache when enormous quantities of data are handled. A further problem with this cache is that, if there is an enormous quantity of data with spatial locality, there is a high probability that data with temporal locality will be purged from the cache, and there will be cases where it will not be possible to make use of that locality.

With the above described cache memory, on the other hand, there are many cases in which cache control is complex, and it is difficult to infer the cache memory situation from outside. Consequently, even if explicit control of cache memory is attempted by means of software, there are limits to that control. A problem with data prefetching, for example, is that prefetching data that will be needed in the future may cause currently needed data to be purged, and it may not be possible to completely prevent the occurrence of thrashing.

### SUMMARY OF THE INVENTION

It is an object of the present invention to provide a cache memory apparatus that solves the above described problems of the conventional technology, enables cache misses, and especially cache misses in the event of cache block conflict, to be reduced, and allows the cache memory situation to be easily inferred from outside, and a data processing system that uses this.

According to the present invention the above described object is attained by providing, in cache memory installed between a processor and a lower-level memory apparatus such as a main memory apparatus or level-2 cache memory configuring a data processing system, a first cache memory controlled explicitly by software and a second cache memory for storing data that cannot be controlled by software such as a cache-miss load.

Also, the above described object is attained by not making a logical distinction between the memory spaces that store the data of the above described first and second cache memories, and by having data read from the above described lower-level memory apparatus by means of a prefetch instruction stored in the above described first cache memory, and having data read from the above described lower-level memory apparatus in the event of a cache-miss stored in the above described second cache memory.

Moreover, the above described object is attained by further providing a target flag that holds information relating to the data storage destination cache memory provided by the above described processor, and a target switch that performs switching so that data read from the above described lower-level memory apparatus is stored in either the above described first or second cache memory according to that flag information.

Further, the above described object is attained by the fact that, in a data processing system configured by providing a cache memory apparatus between the processor and lower-level memory such as a main memory apparatus or level-2 cache memory, the above described cache memory apparatus provided between the processor and lower-level memory is a cache memory apparatus configured as described above.

### BRIEF DESCRIPTION OF THE DRAWINGS

FIG. 1 is a block diagram showing an overview of a configuration of a data processing system provided with a cache memory apparatus according to one embodiment of the present invention;

FIG. 2 is a block diagram showing a configuration of a cache memory apparatus according to one embodiment of the present invention; and

FIG. 3 is a flowchart explaining cache memory control operations.

### DESCRIPTION OF THE EMBODIMENT

With reference now to the attached drawings, an embodiment of a cache memory apparatus and data processing system according to the present invention will be described in detail below.

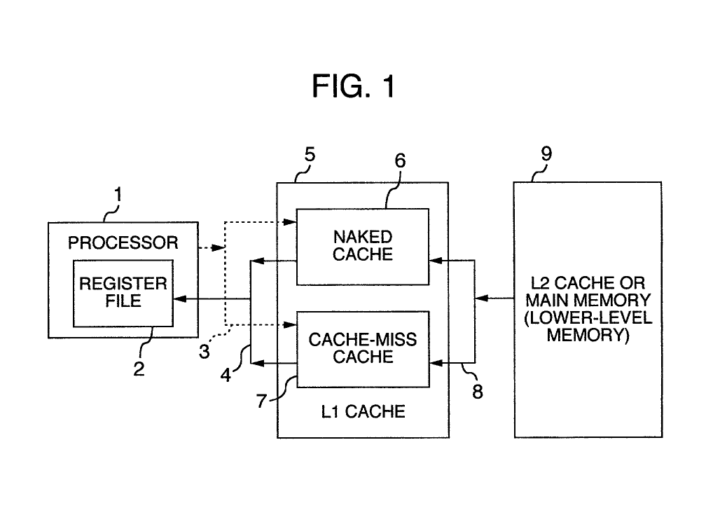

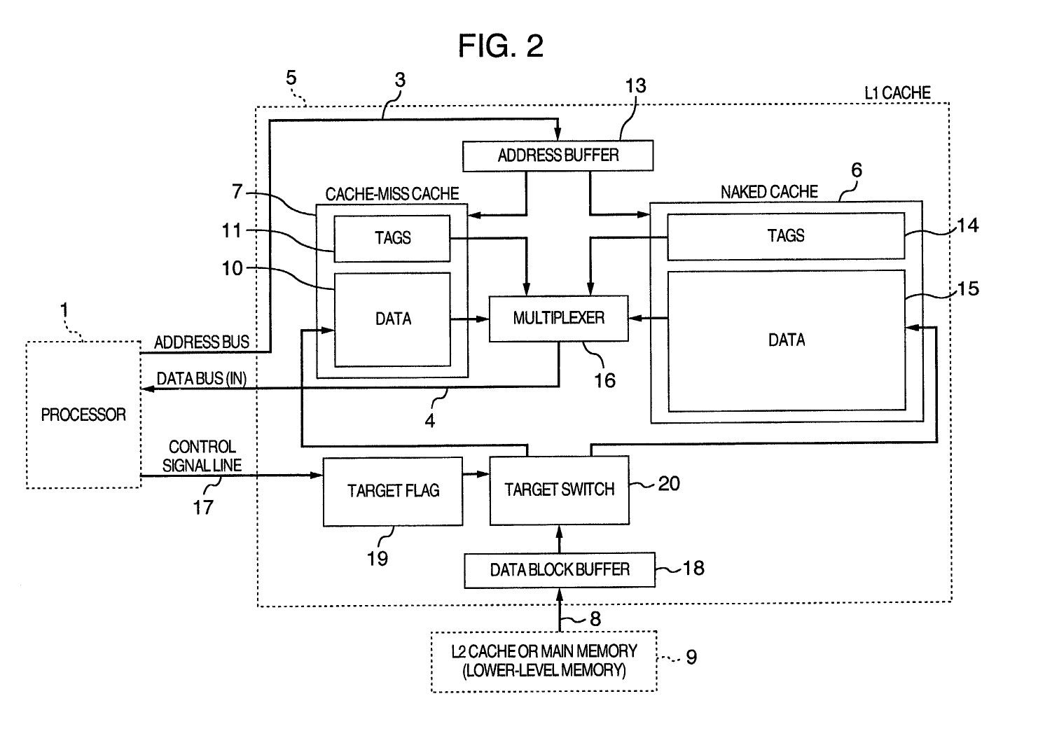

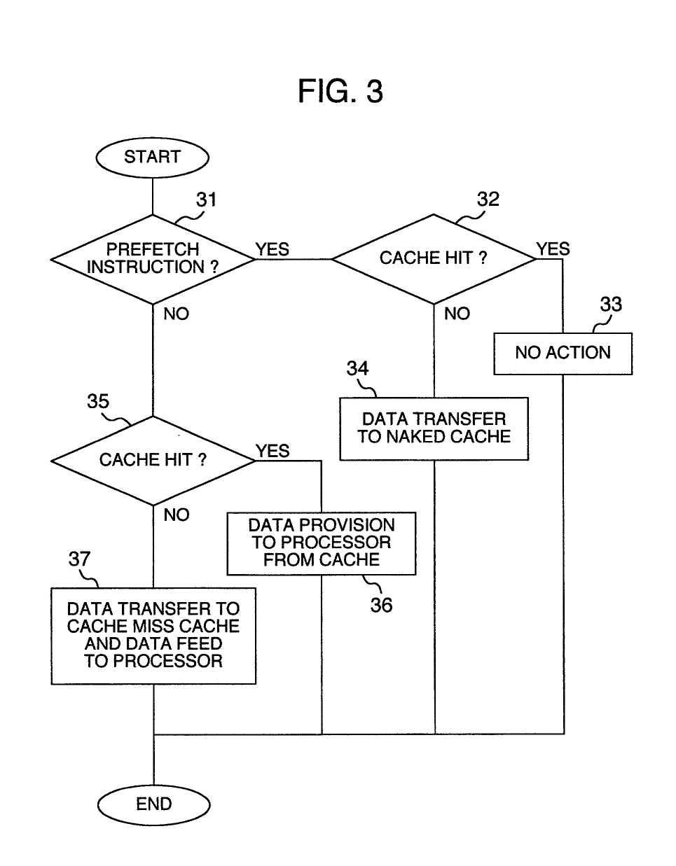

FIG. 1 is a block diagram showing an overview of a configuration of a data processing system provided with a cache memory apparatus according to one embodiment of the present invention, FIG. 2 is a block diagram showing a configuration of a cache memory apparatus according to one embodiment of the present invention, and FIG. 3 is a flowchart explaining cache memory control operations. In FIG. 1 and FIG. 2, reference numeral 1 denotes a processor, reference numeral 2 denotes a register file, reference numeral 3 denotes an address bus, reference numerals 4 and 8 denote a data bus, reference numeral 5 denotes a cache memory apparatus, reference numeral 6 denotes a naked cache, reference numeral 7 denotes a cache-miss cache, reference numeral 9 denotes L2 cache or main memory (lower-level memory), reference numerals 10 and 15 denote data areas, reference numerals 11 and 14 denote tag areas, reference numeral 13 denotes an address buffer, reference numeral 16 denotes a multiplexer, reference numeral 17 denotes a control signal line, reference numeral 18 denotes a data block buffer, reference numeral 19 denotes a target flag, and reference numeral 20 denotes a target switch.

A data processing system provided with the cache memory apparatus according to the embodiment of the present invention shown in FIG. 1 comprises a processor 1 provided with a register file 2; a cache memory 5; and an L2 cache memory apparatus or main memory apparatus (called simply “lower-level memory” below) 9. When an L2 cache memory apparatus is used as the lower-level memory 9, the system further comprises a main memory apparatus. In this case, the cache memory apparatus 5 is used as an L1 cache apparatus.

The cache apparatus 5 used in the system shown in FIG. 1 and located between the processor 1 and the lower-level memory 9 comprises two cache memories 6 and 7 that do not have a mutual master/slave relationship or inclusive relationship. One of the cache memories is naked cache 6 that is controlled explicitly by software, and the other cache memory is cache-miss cache memory 7 used to store data that cannot be controlled by software such as a cache-miss load. In the embodiment of the present invention, a large-capacity (1 MB) 4-way set-associative cache, for example, is used as the naked cache memory 6, and a small-capacity (16 KB) fully-associative cache is used as the cache-miss cache 7.

As shown in the detailed drawing in FIG. 2, the cache memory apparatus 5 comprises the above described naked cache memory 6 and cache-miss cache memory 7, and an address buffer 13 that holds an input address, a multiplexer 16 for selecting hit data, a data block buffer 18 that holds data from the lower-level memory 9, a target flag 19 that holds storage destination cache information, and a target switch 20 that transfers data in the data block buffer 18 to one or other of the above described two cache memories 6 and 7 based on the information of the target flag 19. The naked cache memory 6 and cache-miss cache memory 7 comprise tag areas 11 and 14 and data areas 10 and 15, respectively.

Next, the control operations of the cache memory apparatus 5 will be described with reference to the flowchart shown in FIG. 3. Here, instructions that cause a data transfer to the cache memory apparatus 5 are assumed to be a prefetch instruction or a load instruction.

(1) When a prefetch instruction or load instruction is executed by the processor 1, the relevant address is transferred via the address bus 3 and stored in the address buffer 13. Judgment is made as to whether the instruction is a prefetch instruction, and if it is, the address in the buffer 13 is compared with the contents of the two cache memory tags 11 and 14, and judgment is made as to whether or not there is a cache hit (steps 31 and 32).

(2) If it is judged in step 32 that there has been a hit in either the naked cache memory 6 or the cache-miss cache memory 7, the data to be fetched by this prefetch instruction is already present in cache memory, and therefore no processing is performed and processing is ended at this point (step 33).

(3) If this prefetch instruction produces a cache miss, a data block is stored in the naked cache memory 6 from the lower-level memory 9 via the data block buffer 18. That is, the transferred data is stored temporarily in the data block buffer 18. As the instruction subject to processing is a prefetch instruction, the processor 1 sets the target flag 19 to “0” via the control signal line 17 and orders the data to be stored in the naked cache memory 6. As a result the target switch 20 switches to the naked cache memory 6 side and transfers the data to the naked cache memory 6. As the naked cache memory 6 is 4-way set-associative type memory, if the transfer destination set is already full the least used data block is discarded in accordance with an LRU algorithm, and the transferred data block is stored in an empty location (step 34).

(4) If it is judged in step 31 that the instruction is a load instruction, as in the processing in step 32 the address in the buffer 13 is compared with the contents of the two cache memory tags 11 and 14, and judgment is made as to whether or not there is a cache hit (step 35).

(5) If it is judged in step 35 that there has been a hit in either the naked cache memory 6 or the cache-miss cache memory 7, the data to be fetched by this load instruction is already present in cache memory, and therefore the multiplexer 16 selects the corresponding data from the hit cache memory 6 or 7, and stores this data in the register file 2 of the processor 1 via the data bus 4 (step 36).

(6) If it is judged in step 35 that there has been a cache-miss in both the naked cache memory 6 and the cache-miss cache memory 7—that is, if the load instruction produces a cache miss—a data block is stored from the lower-level memory 9 into the cache-miss cache memory 7 via the data block buffer 18, and at the same time the data corresponding to the load instruction is transferred to the register file 2 of the processor 1. That is to say, the transferred data is stored temporarily in the data block buffer 18. As the instruction subject to processing is a load instruction, the processor 1 sets the target flag 19 to “1” via the control signal line 17 and orders the data to be stored in the cache-miss cache memory 7. As a result the target switch 20 switches to the cache-miss cache memory 7 side and transfers the data to the cache-miss cache memory 7. As the cache-miss cache memory 7 is fully-associative type memory, if there is space in the cache the data is stored in an empty location. If the transfer destination set is already full, the least used data block is discarded in accordance with an LRU algorithm, and the transferred data block is stored in an empty location (step 37).

According to the control of cache memory according to an embodiment of the present invention as described above, even if a conflict miss occurs in the naked cache memory 6, as long as the data is temporarily stored in the cache-miss cache memory 7 thrashing will not occur since the cache-miss cache memory 7 is fully-associative type memory.

According to the above described embodiment of the present invention it is possible to minimize thrashing and cache misses that occur in circumstances that are not predictable by software, such as purging from the private stack cache of a thread.

Also, according to the embodiment of the present invention there is a high probability that data with temporal locality will be stored in the cache-miss cache, and temporal locality can be made use of without using a special algorithm such as a loop tiling algorithm.

Moreover, according to the embodiment of the present invention only data explicitly indicated by software is transferred to the naked cache, and therefore it is possible to provide a cache that is easily controlled by software, and, in particular, to enable a compiler to generate more efficient code.

As described above, according to the embodiment of present invention it is possible to provide a cache memory apparatus that enables cache misses in the event of cache block conflict to be reduced and the cache memory situation to be easily inferred from outside, and to provide a high-performance data processing system utilizing the same.

What is claimed is:

1. A cache memory apparatus installed between a processor and a lower-level memory apparatus such as a main memory apparatus or level-2 cache memory configuring a data processing system, comprising:
a first cache memory controlled explicitly by software; and
a second cache memory for storing data that cannot be controlled by software such as a cache-miss load.

2. The cache memory apparatus according to claim 1, wherein the memory spaces in which the data of said first and second cache memories is stored are not differentiated logically.

3. The cache memory apparatus according to claim 1, wherein said first cache memory is set-associative type cache memory and said second cache memory is fully-associative type cache memory.

4. The cache memory apparatus according to claim 1, wherein data read from said lower-level memory apparatus in the event of a prefetch instruction cache-miss is stored in said first cache memory, and data read from said lower-level memory apparatus in the event of a load instruction cache-miss is stored in said second cache memory.

5. The cache memory apparatus according to claim 3, further comprising:
a target flag that holds information relating to the data storage destination cache memory provided by said processor; and
a target switch that performs switching so that data read from said lower-level memory apparatus is stored in either the above described first or second cache memory according to that flag information.

6. A data processing system configured by providing a cache memory apparatus between a processor and a lower-level storage such as a main memory apparatus or level-2 cache memory or the like, wherein said cache memory apparatus provided between the processor and the lower-level storage is the cache memory apparatus according to claim 1.

7. A data processing system comprising a processor, a lower-level memory apparatus, and a cache memory apparatus that stores part of data of said lower-level memory apparatus, wherein said cache memory apparatus comprises:
a first cache memory controlled explicitly by software; and
a second cache memory that stores data that cannot be controlled by software such as a cache-miss load.

8. The data processing system according to claim 7, wherein the memory spaces in which the data of said first and second cache memories is stored are not differentiated logically.

9. The data processing system according to claim 7, wherein said first cache memory is a set-associative type cache memory and said second cache memory is a fully-associative type cache memory.

10. The data processing system according to claim 7, wherein data read from said lower-level memory apparatus in the event of a prefetch instruction cache-miss is stored in said first cache memory, and data read from said lower-level memory apparatus in the event of a load instruction cache-miss is stored in said second cache memory.

11. The data processing system according to claim 10, further comprising:
a target flag that holds information relating to a data storage destination cache memory provided by said processor; and
a target switch that performs switching so that data read from said lower-level memory apparatus is stored in either the above described first or second cache memory according to that flag information.
